(19) United States
(12) Patent Application Publication
(10) Pub. No.: US 2012/0148080 A1
(43) Pub. Date: Jun. 14, 2012

(54) WIDE ACTION CLAMPING MOUNT FOR COMMUNICATION HEADSET TO HALF-HELMETS, SPORTS HELMETS, AND THE LIKE

(75) Inventors: Avraham Kushnirov, Barkan (IL); Yossef Twina, Rosh-Ha'ayin (IL)

(73) Assignee: Cardo Systems, Inc., Pittsburgh, PA (US)

(21) Appl. No.: 12/962,762

(22) Filed: Dec. 8, 2010

(51) Int. Cl. H04R 1/02

(52) U.S. Cl. 381/333

(57) ABSTRACT

Device for mounting a communication headset to helmets of the type having a first strap extending in front of an ear of a user, a second strap extending behind the ear, and a chin strap connectable to the first and second straps, for instance, sports helmets. The device includes a mounting panel having a seat that includes electrical contacts connected to a printed circuit board and a guide. A rear of the mounting panel spans a distance that overlaps the first second straps. A second surface also spans the distance that overlaps the first and second straps and is movable relative to the mounting panel. A clamp resiliently biases the second surface into contact with the rear surface of the mounting panel but is urgable so as to move the second surface away from the rear surface allowing the device to be fastened to or removed from the helmet.

### FIELD OF THE INVENTION

The present invention relates to improvements in portable communication devices and more particularly to a device for mounting a communication headset.

### BACKGROUND OF THE INVENTION

Today there is a vast array of sports helmets available to a user. Helmets are widely used to enhance the safety of persons riding vehicles such as a bicycle, a motorcycle, a water scooter, a snowmobile and so on. With broader usage of helmets it is desirable for a wearer of a helmet to be able to communicate with other individuals, listen to music, GPS audio commands, and other types of audio signals. It is becoming more popular to use mobile devices to communicate with other users while engaging in activities that include wearing a helmet. However, this is attendant with safety issues, particularly when the user holds the communication device in one hand. Using hands for two different purposes at the same time can distract and lead to accidents. Yet it is desirable for a user wearing a helmet to use electronic devices that have audio signal for the user to hear.

Therefore, it would be desirable to have a communication headset attachable to a helmet in an easy to attach and remove manner. It would be further desirable to provide a mount for such a communication headset that attaches to conventional sports- and head-protection helmets. The present invention addresses these and other needs.

### SUMMARY OF THE INVENTION

According to one aspect of the invention, a device is provided for mounting a communication headset to a helmet of the type having a first strap extending in front of an ear of a user, a second strap extending behind the ear, and a chin strap connectable to the first and second straps. The device includes a mounting panel in a front surface thereof having a seat that includes a set of electrical contacts and a guide. A printed circuit board is in electrical connection with the electrical contacts. The rear surface of the mounting panel is sized to span a distance that overlaps the first and second straps. A second surface is also sized to span a distance that overlaps the first and second straps and is movable relative to the mounting panel. A clamp resiliently biases the second surface into contact with the rear surface of the mounting panel, the clamp being urgable so as to move the second surface away from the rear surface and simultaneously seat at least partially over the first and second straps.

In a further aspect of the inventions, an ear pad is securable to the helmet so as to separate the ear of the user from the second surface and the clamp and to isolate and block noises.

In still a further aspect of the invention, one or more speakers can be in conductive contact with the printed circuit board and provide audio signals to the user.

In still a further aspect of the invention, a remote assembly is in conductive electrical contact with the mounting device to provide audio signals to a second ear of the user.

These and other aspects, features and advantages of the invention can be further appreciated from the accompanying drawing figures and description of certain embodiments of the invention.

### BRIEF DESCRIPTION OF THE DRAWINGS

FIG. 1 illustrates an example of a prior art sports helmet to which a communication headset can be mounted in accordance with an aspect of the invention.

FIG. 2 illustrates a schematic diagram of a sports helmet having a communication headset seated on a mounting device in accordance with one embodiment of the invention.

FIG. 3 illustrates a front view of the mounting device of FIG. 2, partially broken away to reveal a printed circuit board, with the communication headset not being seated thereon.

FIG. 4 illustrates a rearview of the mounting device of FIG. 2 clasping the straps of the helmet.

FIG. 5 illustrates a side view of the mounting device of FIG. 2 held in the open position in order to illustrate certain features thereof.

FIGS. 6A and 6B illustrate schematic diagrams of an ear pad.

FIG. 7 illustrates a schematic diagram of an audio accessory.

FIG. 8 illustrates the audio accessory connected to the mounting device and secured to a helmet in accordance with one embodiment of the invention.

### DETAILED DESCRIPTION OF CERTAIN EMBODIMENTS OF THE INVENTION

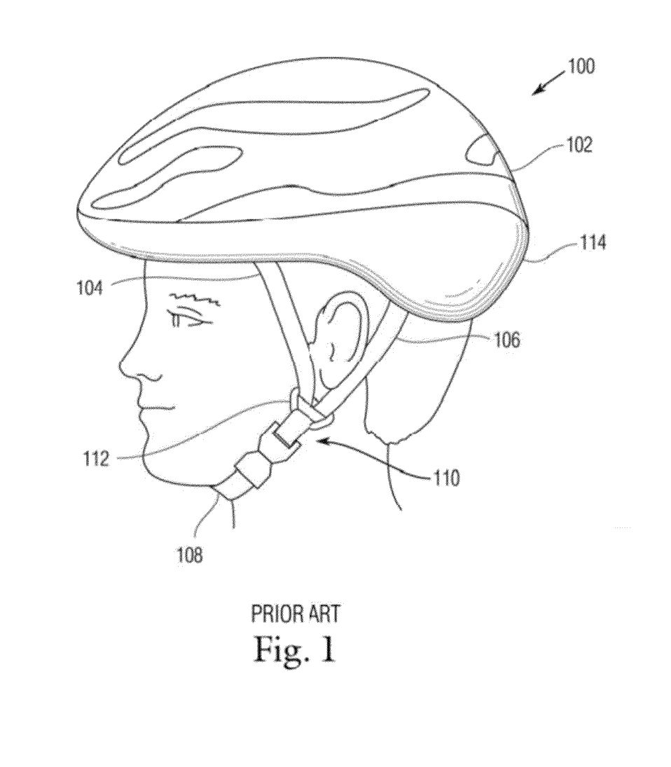

Embodiments of the invention described herein are generally directed to a mounting device configured to attach to a helmet. FIG. 1 illustrates an example of a prior art sports helmet 100 having a hard shell 102 that can be placed on a user's head. The shell 102 includes a first strap 104 extending in front of an ear of the user and a second strap 106 extending behind the ear. A chin strap 108 extends from one side of the shell to other, and is connectable to a free end 110 that joins the first 104 and second straps 106 at a Y-connector 112 to secure the helmet to the head of the user. The straps act as a harness to secure the shell 102 while padding 114 rests between the shell and the user's head to accommodate a range of head sizes.

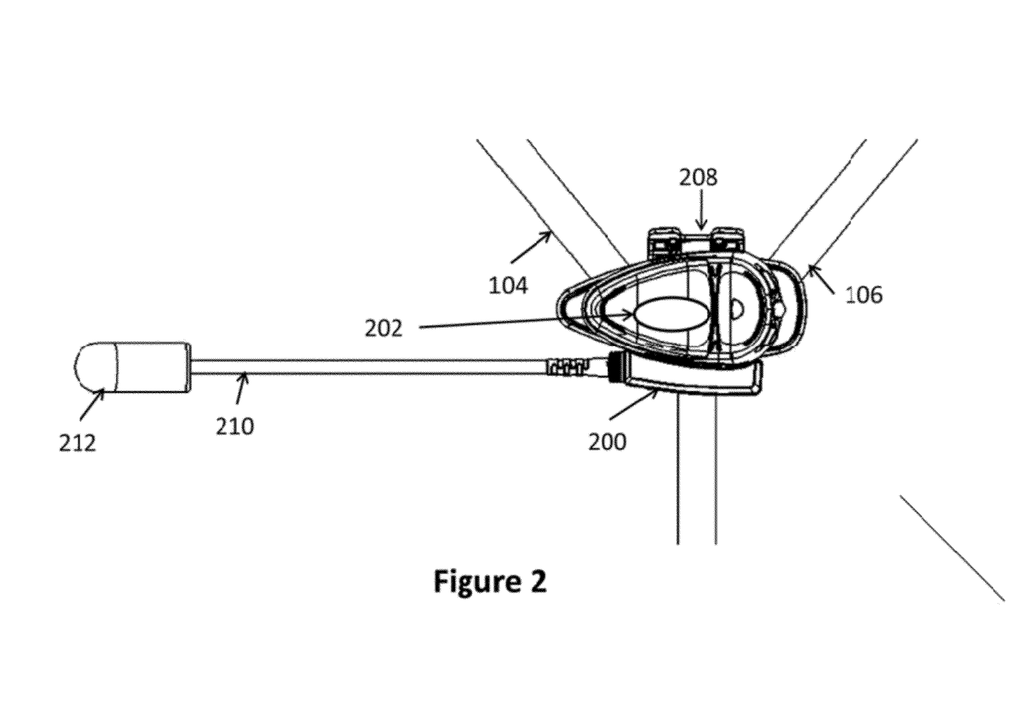

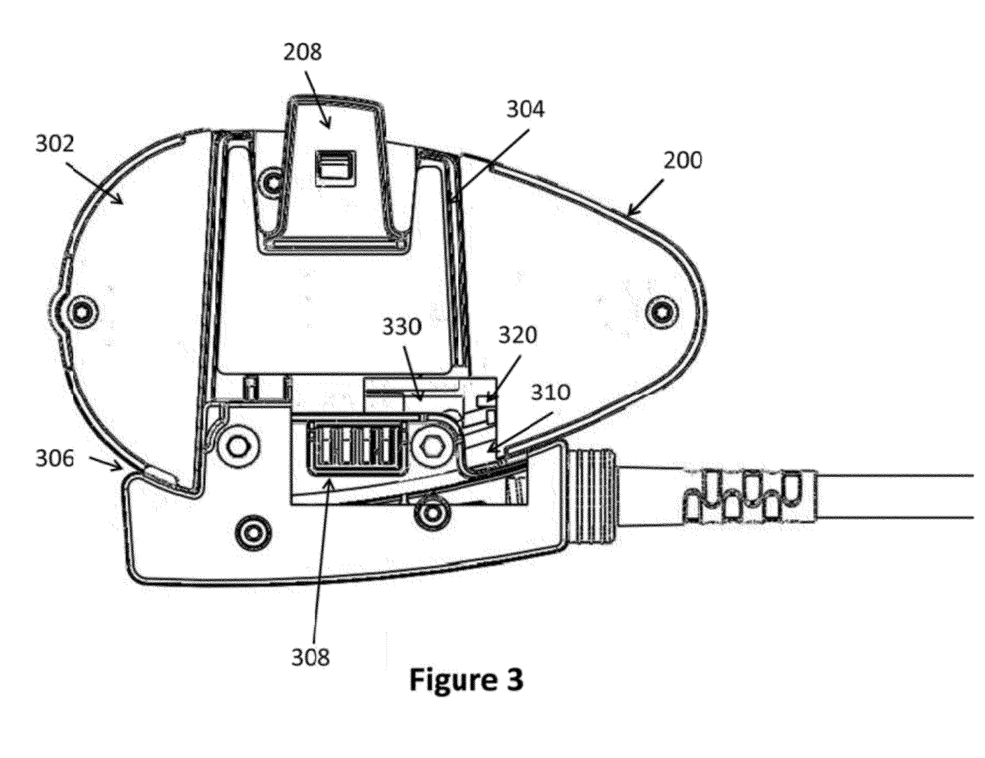

Turning now to FIGS. 2 and 3, a communication headset 202 is shown mounted on the sports helmet 100 by way of a mounting device 200 in accordance with a first embodiment of the invention. The mounting device 200 has a mounting panel 302 with a rear surface sized to span a distance that overlaps the y-straps 104 and 106. Within the mounting panel 302 is a seat 304 that is arranged to receive a communication headset 202. The communication headset 202 is an electronic device configured to provide audible signals to the user's ear(s), and can take on a variety of forms such as a Bluetooth device or a cellular device or a music player. The communication headset 202 forms no part of the present invention. The communication headset 202 seats on the mounting device 200. The communication headset 202 can be unseated from the mounting panel 204 by pressing upon a tab 208. The tab 208 can be configured for manual depressible movement clear of the communication headset 202 so as to release it from the snap-lock engagement.

In one embodiment of the invention, the mounting device 200 has a boom 210 extending from it. Microphone 212 is mounted to a free end of the boom and wires within the boom connect the microphone to the set of contacts 308, directly or by way of a printed circuit board 310.

In FIG. 3 the communication headset 202 has been removed to show further details of the mounting device 200. The mounting panel 304 includes a seat 306 having a set of electrical contacts 308. The contacts 308 are electrically connected by tracings to the printed circuit board 310. The seat 306 limits insertion of communication headset 202 and ensures that the electrical contacts engage corresponding contacts on a rear side of the communication headset. A mounting panel 304 extends from the seat 306 to fingers that are shaped to engage the communication headset 202 and snap-lock the communication headset to the mounting panel 304.

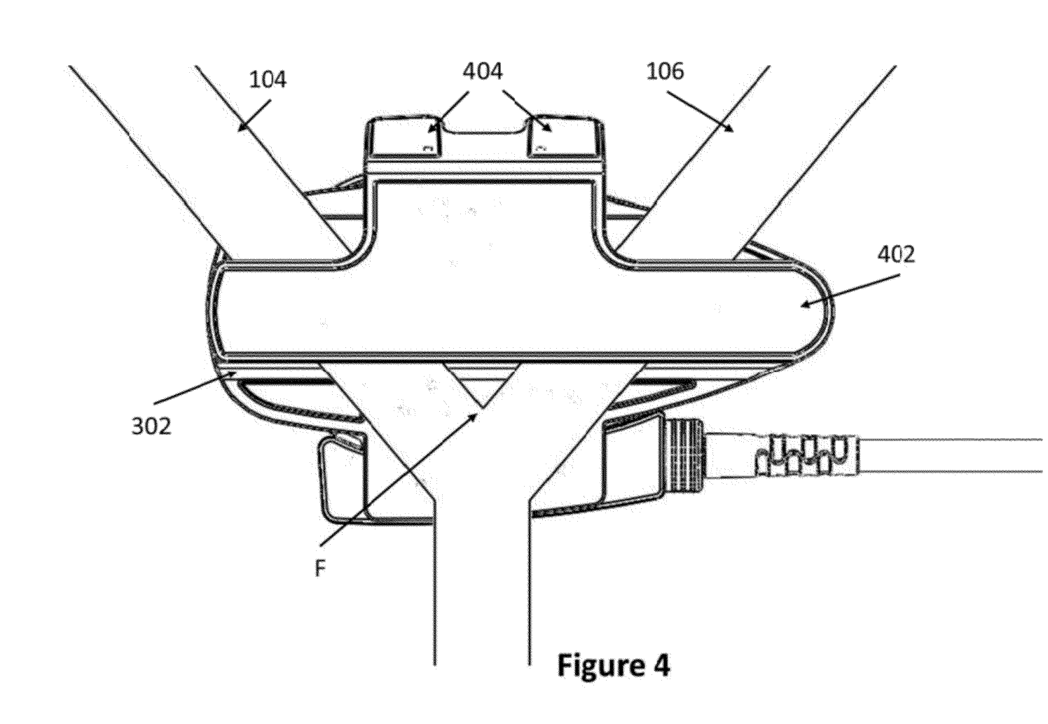

FIGS. 3 and 4 show, respectively, front and rear views of the mounting device, the latter including the helmet straps. The rear surface of the mounting panel 302 and the second surface 402 are shaped and sized to span a distance that overlaps the y-straps 104 and 106 and are positioned to oppose one another. In part, the shape of the front and rear surfaces impart an adjustable positioning capability to the mounting device such that the mounting device can be mounted close to the fulcrum F or remote from the fulcrum while still engaging the straps 104, 106. Such adjustability of the wide-action clamp permits a user to adjust the y-straps to best accommodate the user's ears and head without comprising connectability of the mounting panel to the y-straps. Second surface 402 has tabs 404, which curve toward the mounting panel 302 and can be pressed or urged relative to tab 208 to attach or remove the mounting device 200 to and from the helmet.

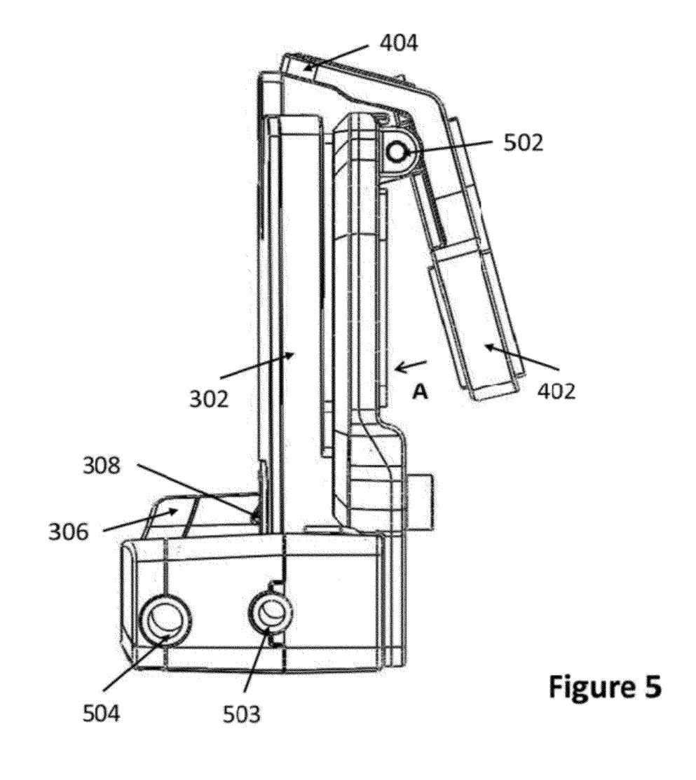

Referring now to FIG. 5, this figure shows a side view of the mounting device while being held in an open position against a restoring force imparted by a biased clamp 502. In particular, second surface 402 is held away from mounting panel 302 by pressing tabs 404. Clamp 502 resiliently biases second surface 402 toward mounting panel 302 in direction A, closing the device when tabs 404 are not pressed. Thus, mounting device 200, with or without communication device 202, can be securely attached to helmet 100 by Y-straps 104 and 106 through the action of clamp 502. Further, the mounting device can be easily attached to or removed from helmet 100 when tabs 404 are pressed. Audio cable jack 504 is electrically connected to the printed circuit board 310 and is used to provide an audio connection to communication headset 202. An additional audio cable jack 503 is also electrically connected to the printed circuit board 310 and is used to provide a direct audio connection between the speakers 706, 708 and an auxiliary audio device such as an MP3 player (not shown).

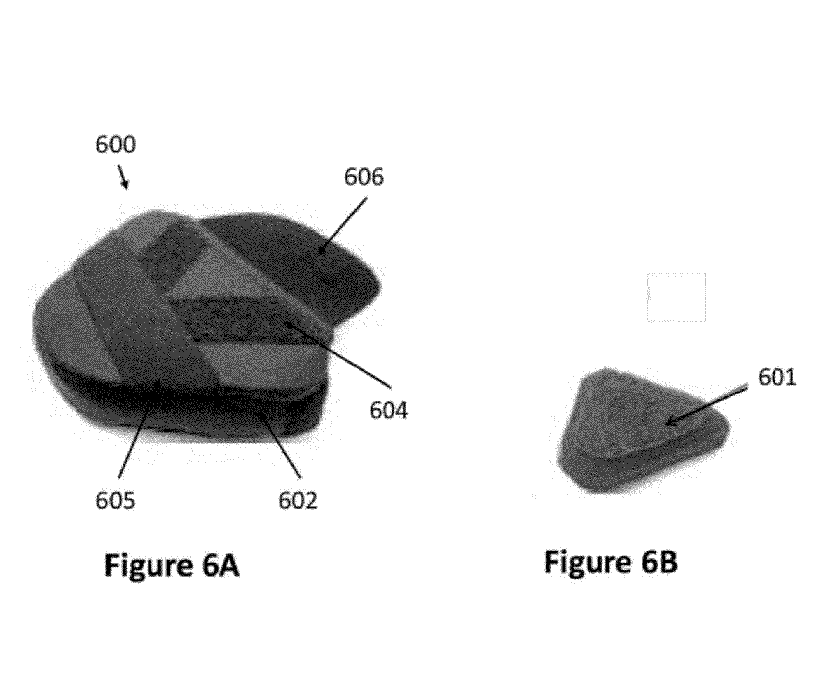

FIGS. 6A and 6B show ear pad 600 in accordance with a further, optional aspect of the invention. When mounting device 200 is attached to helmet 100, ear pad body 602 separates the person's ear from second surface 402 and clamp 502. Hook and look fastener strips 604, tab 606, and elastic strip 605, depicted in FIG. 6A, can be used to secure the ear pad in place within the helmet. For example, hook and look fastener strips 604 can adhere to y-straps 104 and 106 and tab 606 can slip between padding 114 and shell 102 of helmet 100, while elastic strip 605 provides additional security. Internal padding 601, depicted in FIG. 6B is attached to ear pad 600 using hook and look fasteners to increase noise isolation and to position the speaker closer to the ear.

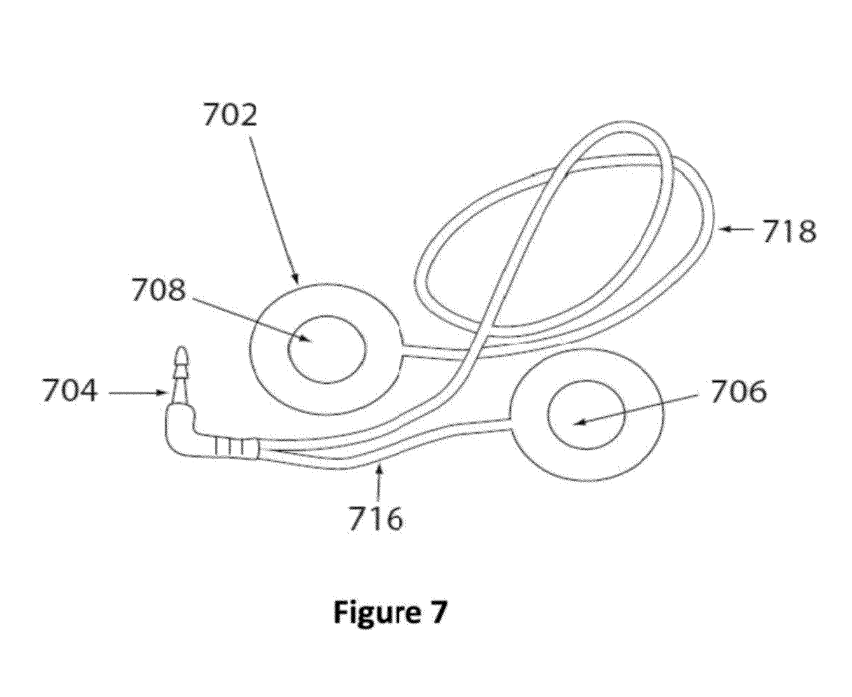

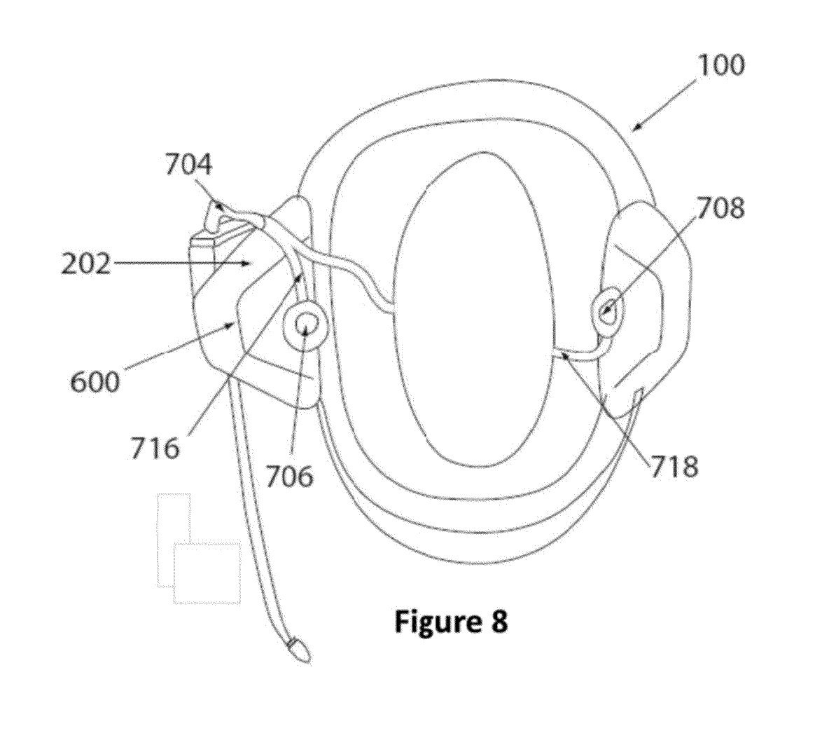

Referring now to FIGS. 7 and 8, audio from communication headset 202 can be provided by audio accessory 702. Audio accessory 702 consists of plug 704, speaker 706, and cable 716. If desired, second speaker 708 and cable 718 can also be included. Audio accessory 702 is removably, electrically connectable with communication headset 202 via a port that connects to the set of electrical contacts or to the printed circuit board 310. In one embodiment, this is accomplished by inserting audio headset plug 704 into audio cable jack 504 supported by the mounting panel 302. As such, the speakers 706 and 708 are or can be communicatively coupled to the communication headset 202 whenever the headset 202 is seated in the mounting panel 304. Meanwhile, speakers 706 and 708 can be secured to ear pad 600 or to internal padding 601 by hook and look fasteners and held securely against the ear pad(s) regardless of whether the helmet 202 is seated in the mounting panel 302 or whether the helmet is disposed on the user's head. Cable 718 can be threaded underneath the cushioning of helmet 100 to minimize contact with the user's head. In an alternative arrangement, cables 716 and 718 can be omitted and the connection to speakers 706 and 708 can instead be a wireless connection such as Bluetooth or radio frequency.

A printed circuit board 310 is disposed within the mounting device 200, as can be seen in FIG. 3. The printed circuit board 310 has conductive tracings in electrical connection with the electrical contacts 308 that mate with the headset when the headset is seated in the mounting panel 304. Optionally, at least one speaker can be in conductive contact with the printed circuit board 310 so that the speaker is communicatively coupled to the communication headset 202 when the headset 202 is seated in the mounting panel 304. Additionally, an auxiliary audio device (not shown) such as an MP3 player can be in conductive contact with the printed circuit board 310 so that the audio device can be communicatively coupled to the communication headset 202 when the headset 202 is seated in the mounting panel 304.

A switch 320 (see FIG. 3) also be communicatively coupled to and/or integrated within the printed circuit board 310. The switch serves to select the source of the audio being provided to speakers 706, 708, based on a pre-defined or user-assigned priority. By way of example, if a user is listening to audio from an MP3 player (connected through audio cable jack 503) while a phone call is received by a cellular device paired with communication headset 202 via Bluetooth, the switch 320 can change the source of the audio being provided to speakers 706, 708 from the MP3 player to the cellular phone, thereby enabling the user to receive the incoming call. The switch can be implemented as code executing in a processor, such as a code module, or can be a hardware element controlled by a processor executing code. In an alternative arrangement, the user can define the priority of various audio sources controlled by the switch 320, thereby dictating which audio sources take precedence over others and which do not by interacting with the device and changing settings thereof. Optionally, the user manually selects the source of the audio being provided to speakers 706, 708 at any time by a control accessible from an exterior of the device 200.

Additionally, a mixer 330 can be communicatively coupled to and/or integrated within the printed circuit board 310 and the switch 320. The mixer serves to manage the various audio sources being provided to speakers 706, 708. In doing so, the mixer can control the volume levels of the various audio sources (e.g, by amplifying or attenuating the audio source signals) in order to ensure a consistent volume level when switching among audio sources. The mixer can combine two (or more) audio sources to be provided to speakers 706, 708 simultaneously. By way of example, the mixer can allow both the audio of a phone call and the audio of a GPS device's turn-by-turn directions to be provided to the speakers 706, 708 simultaneously, thereby enabling the user to continue a phone conversation while receiving updated driving directions. As with the switch 320, the operation of the mixer 330 can be pre-defined in code executing in a processor, and/or defined by the user.

The foregoing discussion of several embodiments is not intended to be restrictive but rather expansive of the permutations that can be had to implement the broad aspects of the present invention. In other words, features and parts of one embodiment can be used in connection with another embodiment.

While the invention has been described in connection with what are presently considered to be the most practical and various embodiments, it is to be understood that the invention is not to be limited to the disclosed embodiments, but on the contrary, is intended to cover various modifications and equivalent arrangements included within the spirit and scope of the appended claims.

We claim:

1. A device for mounting a communication headset to helmets of the type having a first strap extending in front of an ear of a user and a second strap extending behind the ear and a chin strap connectable to the first and second straps to secure the helmet to a head of the user, comprising:
a mounting panel having a seat in a front surface thereof that includes a set of electrical contacts and a guide, the mounting panel further having a rear surface sized to span a distance that overlaps the first and second straps;
a printed circuit board in electrical connection with the electrical contacts;
a second surface movable relative to the mounting panel and sized to span the distance that overlaps the first and second straps; and
a clamp resiliently biasing the second surface into contact with the rear surface of the mounting panel, the clamp being urgable so as to move the second surface away from the rear surface and simultaneously seat at least partially over the first and second straps.

2. The device of claim 1, further comprising an ear pad securable to the helmet so as to separate the ear of the user from the second surface and the clamp.

3. The device of claim 1, further comprising:
a boom mounted to the mounting panel, the boom having a free end; and
a microphone mounted to the free end of the boom.

4. The device of claim 1, wherein the mounting panel includes fingers shaped and positioned to snap-lock engage the communication headset to the mounting panel.

5. The device of claim 4, wherein the mounting panel further comprises a tab configured for manual depressable movement so as to release the communication headset from the snap-lock engagement.

6. The device of claim 1, further comprising a wire in conductively electrical contact with the set of electrical contacts and extending to one or more speakers.

7. The device of claim 6, further comprising an auxiliary audio device connected to a wire which is in electrical conductive contact with the set of electrical contacts.

8. The device of claim 1, further comprising one or more speakers in conductive contact with the printed circuit board.

9. The device of claim 1, further comprising a switch communicatively coupled to the printed circuit board that enables the selection of an audio source.

10. The device of claim 1, further comprising a mixer communicatively coupled to the printed circuit board that enables the management of one or more audio sources.
